(19) United States
(12) Patent Application Publication
(10) Pub. No.: US 2020/0164989 A1
(43) Pub. Date: May 28, 2020

(54) JET ENGINE COMPRISING A DRAWING SYSTEM INTENDED TO DRAW AIR FROM SAID JET ENGINE

(71) Applicant: Airbus Operations SAS, Toulouse (FR)

(72) Inventors: Pierre-Alain PINAULT, TOURNEFEUILLE (FR); Stephane WARNET, GRENADE SUR GARONNE (FR); Stéphane MACHADO, MONTAUBAN (FR)

(21) Appl. No.: 16/687,148

(22) Filed: Nov. 18, 2019

(30) Foreign Application Priority Data
Nov. 20, 2018 (FR) 1871616

(51) Int. Cl. B64D 13/06; F02C 9/18; B64D 13/02

(52) U.S. Cl. CPC B64D 13/06; F02C 9/18; B64D 13/02; F05D 2260/213; F05D 2260/606; B64D 2013/0644; B64D 2013/0648; F05D 2220/323; F05D 2270/303; B64D 2013/0618

(57) ABSTRACT

A two-flow jet engine comprising a high-pressure compressor and a drawing system configured to draw air from said jet engine and send it to an air system, and which comprises a pressurized air supply which draws pressurized air from the high-pressure compressor, a pipe which draws outside air, a turbine of which an inlet is connected to the outlet of the pressurized air supply, and a compressor of which an inlet is connected to the pipe, and an outlet is connected to the air system, and where the rotation of the turbine drives the rotation of the compressor. This particular arrangement makes possible an energy gain by virtue of the combined action of the turbine and of the compressor.

### CROSS-REFERENCES TO RELATED APPLICATIONS

This application claims the benefit of the French patent application No. 1871616 filed on Nov. 20, 2018, the entire disclosures of which are incorporated herein by way of reference.

### FIELD OF THE INVENTION

The present invention relates to an aircraft jet engine comprising a system for drawing air from said jet engine to supply an air system of said aircraft, and to an aircraft comprising at least one such jet engine.

### BACKGROUND OF THE INVENTION

FIG. 1 shows a two-flow jet engine 10 of an aircraft, equipped with a prior art drawing system 100 which is intended to draw air from the jet engine 10 and to send it to an air system 60 such as the air conditioning system 60 of the cabin of the aircraft.

The jet engine 10 comprises:
a fan 12 intended to generate a flow of air in the jet engine 10 in a direction 50 of movement of the air in the jet engine, where, as is known, the flow of air then moves downstream from the fan both through a primary air duct of the jet engine 10 and through a secondary air duct V thereof,
an engine compressor 40 which comprises a low-pressure compressor 16 downstream of the fan 12 and a high-pressure compressor 18 located downstream of the low-pressure compressor 16,
an engine turbine 20 which comprises a high-pressure turbine 22 downstream of the high-pressure compressor 18, and a low-pressure turbine 24 downstream of the high-pressure turbine 22.

The air which is pushed by the fan 12 and which passes through the primary duct passes successively through the low-pressure compressor 16, the high-pressure compressor 18, the high-pressure turbine 22 and the low-pressure turbine 24, whereupon it is ejected to the outside.

Between the high-pressure compressor 18 and the high-pressure turbine 22, the air passes through a combustion chamber 26.

The high-pressure compressor 18 comprises multiple compression stages where the pressure increases, from upstream to downstream in the direction of movement 50, from a low pressure at the first stage to a high-pressure at the last stage, passing through intermediate pressures in the intermediate stages.

The drawing system 100 comprises:
a first air intake 102 intended to draw low-pressure or intermediate-pressure air from the high-pressure compressor 18,
a second air intake 104 intended to draw high-pressure air from the high-pressure compressor 18,
a check valve 106 which is fluidically connected to the first air intake 102 and which prevents the air from moving towards said first air intake 102,
a high-pressure valve 108 which is fluidically connected to the second air intake 104 and is controlled so as to be either open or closed,
a regulating valve 110 intended to regulate the pressure of the flow of air passing through it, the outlet of the high-pressure valve 108 and the outlet of the check valve 106 being fluidically connected to a single inlet of the regulating valve 110,
a heat exchanger 112 intended to exchange heat between two flows of air passing through it, in particular to cool the air coming from the outlet of the regulating valve 110 which is fluidically connected to a first inlet of the heat exchanger 112, and where a first outlet of the heat exchanger 112 corresponding to its first inlet is fluidically connected to the air system 60 of the aircraft,
a control unit 114 intended to control the high-pressure valve 108 and the regulating valve 110.

The air required for the cooling carried out in the heat exchanger 112 is drawn via a pipe 116 arranged downstream of the fan 12 in the secondary air duct V of the jet engine 10. This fresh air enters via a second inlet of the heat exchanger 112 and passes through the latter, reaching a second outlet where it is expelled to the outside. This fresh air is heated by exchange of heat with the air from the outlet of the regulating valve 110.

In order to regulate the pressure of the air originating from the high-pressure compressor 18, the drawing system 100 comprises a pressure sensor 111 which detects the value of the pressure downstream of the regulating valve 110. The information provided by the pressure sensor 111 is transmitted to the control unit 114, which controls the high-pressure valve 108 and the regulating valve 110 accordingly.

In order to regulate the temperature of the air supplied to the air system 60, the drawing system 100 comprises, on the pipe 116, a regulating valve 118 and a temperature sensor 120 which detects the value of the temperature at the outlet of the heat exchanger 112 upstream of the air system 60. The information provided by the temperature sensor 120 is transmitted to the control unit 114, which controls the regulating valve 118 accordingly.

An installation of this kind is not always satisfactory in terms of energy consumption.

### SUMMARY OF THE INVENTION

One object of the present invention is to propose a jet engine comprising a drawing system and which permits an energy gain in comparison to the prior art.

To that end, there is proposed a two-flow jet engine comprising a high-pressure compressor, a secondary air duct and a drawing system intended to draw air from the jet engine and send it to an air system, and which comprises
a pressurized air supply which draws pressurized air from the high-pressure compressor,
a pipe arranged so as to draw outside air from the secondary air duct,
a turbine which has a rotary shaft and of which an inlet is fluidically connected to the outlet of the pressurized air supply, and
a compressor which has a rotary shaft and of which an inlet is fluidically connected to the pipe, and an outlet is fluidically connected to the air system,

where the rotation of the turbine drives the rotation of the compressor,

the jet engine being characterized in that the drawing system comprises a heat exchanger, in that the outlet of the compressor is fluidically connected to a first inlet of the heat exchanger, in that a first outlet of the heat exchanger corresponding to the first inlet is fluidically connected to the air system, in that an outlet of the turbine is fluidically connected to a second inlet of the heat exchanger, and in that a second outlet of the heat exchanger corresponding to the second inlet evacuates the cooled air to the outside.

This particular arrangement makes possible an energy gain by virtue of the combined action of the turbine and of the compressor.

### BRIEF DESCRIPTION OF THE DRAWINGS

The abovementioned features of the invention, along with others, will become more clearly apparent on reading the following description of one exemplary embodiment, said description being given with reference to the appended drawings, in which:

FIG. 1 is a schematic representation of a two-flow jet engine of an aircraft, equipped with a drawing system according to the prior art,

FIG. 2 is a side view of an aircraft comprising a two-flow jet engine according to the invention,

FIG. 3 is a schematic representation of a two-flow jet engine of an aircraft, equipped with a drawing system according to a first embodiment of the invention, and

FIG. 4 is a schematic representation of a two-flow jet engine of an aircraft, equipped with a drawing system according to a second embodiment of the invention.

### DETAILED DESCRIPTION OF THE PREFERRED EMBODIMENTS

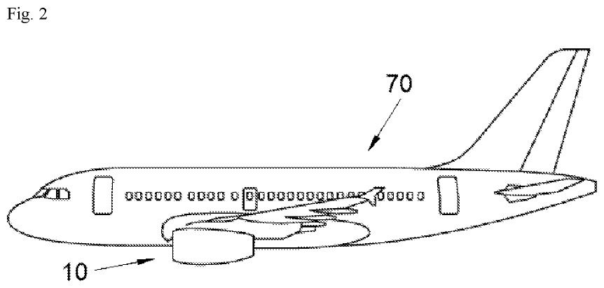

FIG. 2 shows an aircraft 70 equipped with a two-flow jet engine 10.

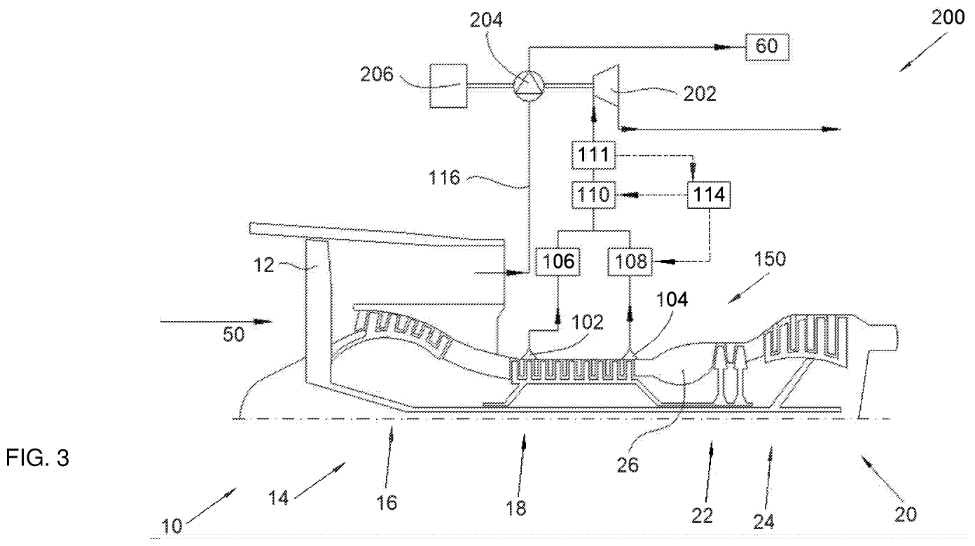

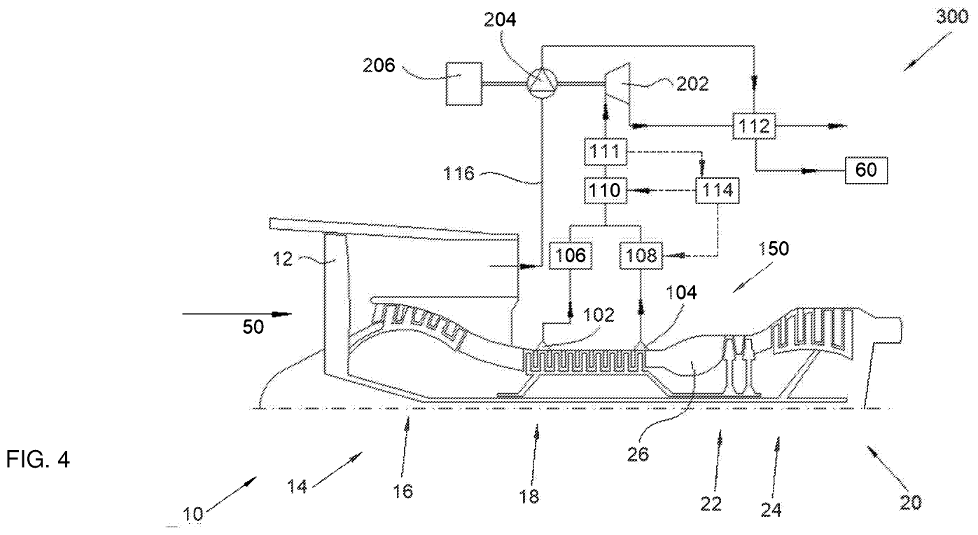

FIG. 3 and FIG. 4 show the jet engine 10 equipped with a drawing system 200, 300 according to the invention, which is intended to draw air from the jet engine 10 and to send it to an air system 60 such as the air conditioning system 60 of the cabin of the aircraft.

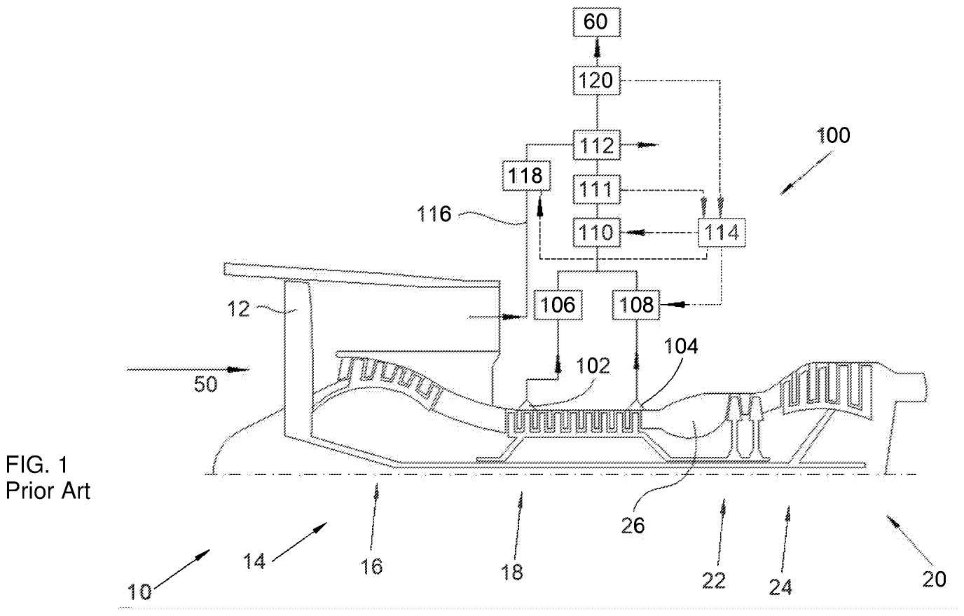

The jet engine 10 comprises the same elements as that of FIG. 1, in particular, a fan 12, an engine compressor 14 with a low-pressure compressor 16 and a high-pressure compressor 18, and an engine turbine 20 with a high-pressure turbine 22 and a low-pressure turbine 24, and a combustion chamber 26. These elements bear the same references.

The high-pressure compressor 18 comprises multiple compression stages where the pressure increases, from upstream to downstream in a direction of movement 50 of the air in the jet engine, from a low pressure at the first stage to a high-pressure at the last stage, passing through a succession of intermediate pressures at each one of the intermediate stages.

The drawing system 200, 300 comprises a pressurized air supply 150 which draws pressurized air from the high-pressure compressor 18. In the embodiment of the invention, the pressurized air supply 150 comprises:
a first air intake 102 intended to draw low-pressure or intermediate-pressure air from the high-pressure compressor 18,
a second air intake 104 intended to draw high-pressure air from the high-pressure compressor 18,
a check valve 106 of which the inlet is fluidically connected to the first air intake 102 and which prevents the air from moving towards the first air intake 102,
a high-pressure valve 108 which is fluidically connected to the second air intake 104 and is controlled so as to be either open or closed,
a regulating valve 110 intended to regulate the pressure of the flow of air passing through it, the outlet of the high-pressure valve 108 and the outlet of the check valve 106 being fluidically connected to a single inlet of the regulating valve 110, and
a control unit 114 intended to control the high-pressure valve 108 and the regulating valve 110.

In order to regulate the pressure of the air originating from the high-pressure compressor 18, the pressurized air supply 150 comprises a pressure sensor 111 which detects the value of the pressure downstream of the regulating valve 110. The information provided by the pressure sensor 111 is transmitted to the control unit 114 which controls the high-pressure valve 108 and the regulating valve 110 accordingly. Of course, it is possible for the pressure sensor 111 to have a different position.

The drawing system 200, 300 also comprises a turbine 202, the inlet of which is fluidically connected to the outlet of the pressurized air supply 150 which in this case is the regulating valve 110. The pressurized air coming from the pressurized air supply 150, in this case from the regulating valve 110, thus drives the turbine 202.

The drawing system 200, 300 also comprises a pipe 116 arranged to draw outside air. In the embodiment of the invention shown in FIGS. 3 and 4, the pipe 116 is arranged downstream of the fan 12 in the secondary air duct V of the jet engine 10 for the purpose of drawing fresh air from behind the fan 12, but the pipe 116 can be arranged to draw air directly from outside the jet engine 10.

The drawing system 200, 300 also comprises a compressor 204, the inlet of which is fluidically connected to the pipe 116.

In the first embodiment of the invention, the outlet of the compressor 204 is fluidically connected directly to the air system 60. The fresh air from the fan 12 is thus heated and pressurized through the compressor 204, whereupon it is introduced into the air system 60. Upon leaving the turbine 202, the air is directly ejected to the outside.

In the second embodiment of the invention, the drawing system 300 also comprises a heat exchanger 112 intended to exchange heat between two flows of air passing through it. The heat exchanger 112 is positioned downstream of the turbine 202 and of the compressor 204.

Thus, the outlet of the compressor 204 is fluidically connected indirectly to the air system 60 and, upon leaving the turbine 202, the air is indirectly ejected to the outside.

The outlet of the compressor 204 is then fluidically connected to a first inlet of the heat exchanger 112. The first outlet of the heat exchanger 112 corresponding to the first inlet is fluidically connected to the air system 60. Thus, the fresh air from the fan 12 is heated through the compressor 204 and the heat exchanger 112 and pressurized through the compressor 204.

The outlet of the turbine 202 is fluidically connected to a second inlet of the heat exchanger 112. The second outlet of the heat exchanger 112 corresponding to the second inlet expels the cooled air to the outside. The flow of air leaving the turbine 202 constitutes the flow of hot air entering the heat exchanger 112.

The heat exchanger 112 exchanges heat between the two flows of air passing through it, in particular to heat the air coming from the compressor 204 by cooling the air coming from the turbine 202.

In both embodiments, the rotary shaft of the turbine 202 drives the rotary shaft of the compressor 204, hence the rotation of the turbine 202 drives the rotation of the compressor 204. Driving can be direct, via a common rotary shaft comprising the rotary shaft of the compressor 204 and the rotary shaft of the turbine 202, or indirect, via a gearbox between the rotary shaft of the compressor 204 and the rotary shaft of the turbine 202 if different rotation speeds are preferred.

Moreover, it is easier to heat up the fresh air to bring it to an ambient temperature than it is to cool the hot air of the engine compressor 14 to bring it to the same ambient temperature since the temperature difference is smaller in the first instance.

In order to avoid the air from the pressurized air supply 150 mixing with the air from the fan 12, the turbine 202 and the compressor 204 do not have a common casing, that is to say, the turbine 202 has its own casing and the compressor 204 also has its own casing, which is different from the casing of the turbine 202.

The jet engine 10 may also comprise an additional, reversible electric motor 206 which can operate equally well as a generator or a motor. The shaft of the additional electric motor 206 is mechanically connected to the shaft of the compressor 204, either directly or via the intermediary of a gearbox. The mechanical connection of the additional electric motor 206 to the compressor 204 can preferably be activated/deactivated by the action of servocontrols (not shown).

When the compressor 204 is driven by the turbine 202, the shaft of the additional motor 206 is driven by the shaft of the compressor 204 and the additional motor 206 operates as a generator to charge batteries (for example, arranged in the jet engine).

Conversely, during certain flight conditions, when it is necessary to avoid drawing air from the high-pressure compressor 18 in order to be able to use the turbomachine optimally, the additional motor 206, powered by batteries, operates as a motor to drive the compressor 204 and its shaft drives the shaft of the compressor 204.

The control unit conventionally comprises, connected by a communication bus: a processor or CPU (central processing unit); a random access memory (RAM); a read-only memory (ROM); a storage unit such as a hard disk or a storage medium reader; at least one communication interface which for example allows the control unit to communicate with the motors, actuators and/or other elements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A two-flow jet engine comprising a high-pressure compressor, a secondary air duct and a drawing system configured to draw air from said jet engine and send the drawn air to an air system, and which comprises:
a pressurized air supply configured to draw pressurized air from the high-pressure compressor,
a pipe configured to draw outside air from the secondary air duct,
a turbine having a rotary shaft and of which an inlet is fluidically connected to an outlet of the pressurized air supply, and
a compressor having a rotary shaft and of which an inlet is fluidically connected to the pipe, and an outlet is fluidically connected to the air system,
wherein a rotation of the turbine drives the rotation of the compressor,
wherein the drawing system comprises a heat exchanger,
wherein the outlet of the compressor is fluidically connected to a first inlet of the heat exchanger,
wherein a first outlet of the heat exchanger corresponding to the first inlet is fluidically connected to the air system,
wherein an outlet of the turbine is fluidically connected to a second inlet of the heat exchanger, and
wherein a second outlet of the heat exchanger corresponding to the second inlet evacuates cooled air to the outside.

2. The jet engine according to claim 1, wherein the rotary shaft of the compressor and the rotary shaft of the turbine form a common rotary shaft.

3. The jet engine according to claim 1, further comprising a gearbox between the rotary shaft of the compressor and the rotary shaft of the turbine.

4. The jet engine according to claim 1, wherein the turbine has its own casing and wherein the compressor also has its own casing which is different from the casing of the turbine.

5. The jet engine according to claim 1, further comprising an additional electric motor of which the shaft is mechanically connected to the shaft of the compressor.

6. An aircraft comprising at least one jet engine according to claim 1.
